(19) United States
(12) Patent Application Publication
(10) Pub. No.: US 2006/0050774 A1
(43) Pub. Date: Mar. 9, 2006

(54) Method and device for estimating the transfer function of a channel for the variable transmission of a multicarrier signal

(76) Inventor: Stephane De Marchi, Paris (FR)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/515,250

(22) PCT Filed: May 20, 2003
(86) PCT No.: PCT/FR03/01525

§ 371 Date: Nov. 19, 2004

(30) Foreign Application Priority Data
May 24, 2002 (FR) 0206391

(51) Int. Cl. H04B 1/707; H04B 1/69

(52) U.S. Cl. 375/150

(57) ABSTRACT

The method of estimating the transfer function of a varying transmission channel for a multicarrier signal (A) is performed on the basis of a frequency-domain digital signal (Y) corresponding to the received signal, and it comprises a step (6) of calculating the value of a first estimated transfer function (C1) for the transmission channel. The method is characterized in that it further comprises: a step (8) of calculating the value of the autocorrelation function (R(C1)) of said first estimated transfer function (C1) enabling the contribution from noise to be separated out; a step (10) of determining a noise-removal filter (F) from said autocorrelation function (R(C1)); and a step (12) of applying said noise-removal filter (F) to said first estimated transfer function (C1) in order to deliver a second estimated transfer function (C2) of the transmission channel from which noise has been removed. The invention is particularly applicable to receiving digital TV signals.

The present invention relates to a method and to apparatus for improved estimation of the transfer function of a varying transmission channel for transmitting a multicarrier signal.

In the context in particular of radio transmission, it is common practice to make use of modulation techniques that enable so-called “multicarrier” signals to be transmitted that enable information to be transmitted by multiplexing carriers at different frequencies.

For example, in the modulation techniques known as orthogonal frequency-division multiplexing (OFDM) or coded OFDM (COFDM), binary data is transmitted by being modulated on carriers of different frequencies.

For example, in the context of applying OFDM or COFDM to transmitting digital TV information, the usable passband which may be about 8 megahertz (MHz) with a spacing between carriers of 1 kilohertz (Hz) enables more than 8000 carriers of different frequencies to be used.

These signals are then subdivided in time into blocks that are known as “symbols” and that are of a duration that enables one period of the lowest carrier frequency to be sent, for transmission by radio.

Radio transmission leads to propagation irregularities due, amongst other things, to reflections and echoes induced by the environment, and to the fact that a plurality of transmitters are used.

Such transmission thus leads to the amplitude and the phase of each of the carriers in the transmitted signal being modified.

In order to model such modifications, the transmission channel is defined in the form of a transfer function, such that the received signal corresponds to the signal as transmitted and as transformed by said transfer function, and to which noise is also added.

In order to correct for the influence of radio transmission, reference carriers known as “pilots” are introduced into the transmitted signal, which pilots are known in advance and make it possible at the receiver to estimate the modifications to which the signal has been subjected by being transmitted, and thus makes it possible to estimate the transfer function of the transmission channel.

In order to perform this estimation, existing methods and apparatuses are based on the assumption that the transmission channel varies slowly and continuously, so as to make it possible to use a plurality of consecutive channel estimates in order to distinguish between the transfer function of the transmission channel and noise that is independent of the channel.

Nevertheless, when variations in a transmission channel take place quickly and/or discontinuously, the above assumption no longer applies.

Specifically, for the application to receiving while on the move, or while in the presence of moving bodies (people, vehicles) close to the receiver antennas and giving rise to varying reception conditions, the use of existing methods and apparatuses lead to erroneous estimates of the transfer function of the channel, which in turn lead to inappropriate corrections that cause signal losses to occur.

The object of the invention is to solve that problem by defining a method and apparatus for improved estimation of the transfer function of a varying transmission channel.

The present invention thus provides a method of estimating the transfer function of a varying transmission channel for a multicarrier signal including a plurality of known reference data items referred to as pilots, said method being implemented from a frequency-domain digital signal corresponding to the signal as received, digitized, synchronized, and transformed from a time base to a frequency base, and including a step of calculating the value of a first estimated transfer function for the transmission channel on the basis of the pilots contained in said frequency-domain digital signal, the method being characterized in that it further comprises:
a step of calculating the value of the autocorrelation function of said first estimated transfer function enabling to separate out the contribution from noise;
a step of determining a noise-removal filter from said autocorrelation function; and
a step of applying said noise-removal filter to said first estimated transfer function in order to deliver a second estimated transfer function of the transmission channel from which noise has been removed.

According to other characteristics of the method:
it is implemented periodically;
it is implemented continuously; and
said step of calculating a first estimated transfer function comprises a substep of calculating the modifications to which the pilots have been subjected in order to define the value of the transfer function of the transmission channel for said carriers and a substep of interpolating between said values in order to deliver said first estimated transfer function.

The invention also provides a method of receiving a multicarrier signal, characterized in that it includes a method of estimating the transfer function of the transmission channel of said multicarrier signal as described above, and in that it further includes a step of compensating the modifications to which said multicarrier signal has been subjected during transmission on the basis of said second estimated transfer function from which noise has been removed, in order to deliver estimated data.

According to other characteristics of this reception method:
it includes a plurality of prior steps of processing the received signal in order to deliver said frequency-domain digital signal; and
said multicarrier signal is a digital TV signal modulated by orthogonal frequency-division multiplexing.

The invention also provides apparatus for estimating the transfer function of a varying transmission channel for a multicarrier signal including a plurality of known reference items of information referred to as pilots, said apparatus receiving as input a frequency-domain digital signal corresponding to the signal as received, digitized, synchronized, and transformed from a time base to a frequency base, and including a module for calculating the value of a first estimated transfer function of the transmission channel from the pilots contained in said frequency-domain digital signal, the apparatus being characterized in that it further comprises:
a module for calculating the value of the autocorrelation function of said first estimated transfer function enabling the contribution of noise to be separated out;
a module for determining a noise-removal filter from said autocorrelation function; and
a module for applying said noise-removal filter to said first estimated transfer function in order to deliver a second estimated transfer function of the transmission channel from which noise has been removed.

According to other characteristics of this apparatus:
it is adapted to operate periodically; and
it is adapted to operate continuously.

The invention also provides a receiver unit for receiving a multicarrier signal, the unit being characterized in that it includes apparatus for estimating the transfer function of the transmission channel as defined above, and in that it further includes a module for compensating the influence of the transmission channel in order to modify said frequency-domain digital signal as a function of said second estimated transfer function from which noise has been removed, in order to deliver estimated data.

According to other characteristics of this unit:
it further includes a preprocessing system adapted to receive said multicarrier signal, and to deliver said frequency-domain digital signal;
it is adapted to receive digital TV signals modulated by orthogonal frequency-division multiplexing; and
it is mobile.

The invention also provides a computer program, characterized in that it comprises program code instructions for executing the steps of the method as defined above, when said program is executed on a computer.

Finally, the invention provides a programmed component, characterized in that it comprises a logical configuration dedicated to executing the steps of the method as defined above.

The invention will be better understood on reading the following description, given purely by way of example and given with reference to the accompanying drawings, in which:

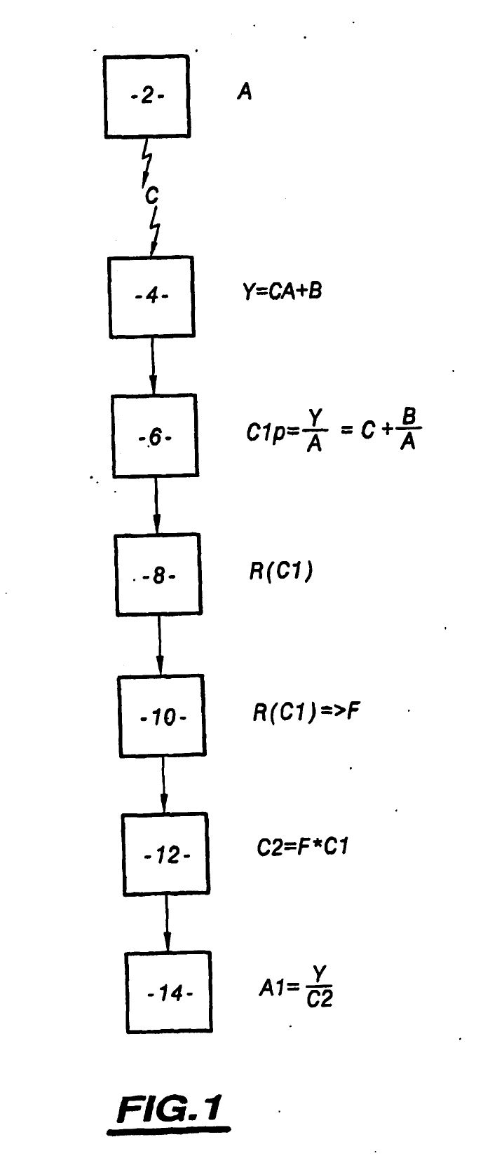

FIG. 1 is a flow chart of the method of the invention; and

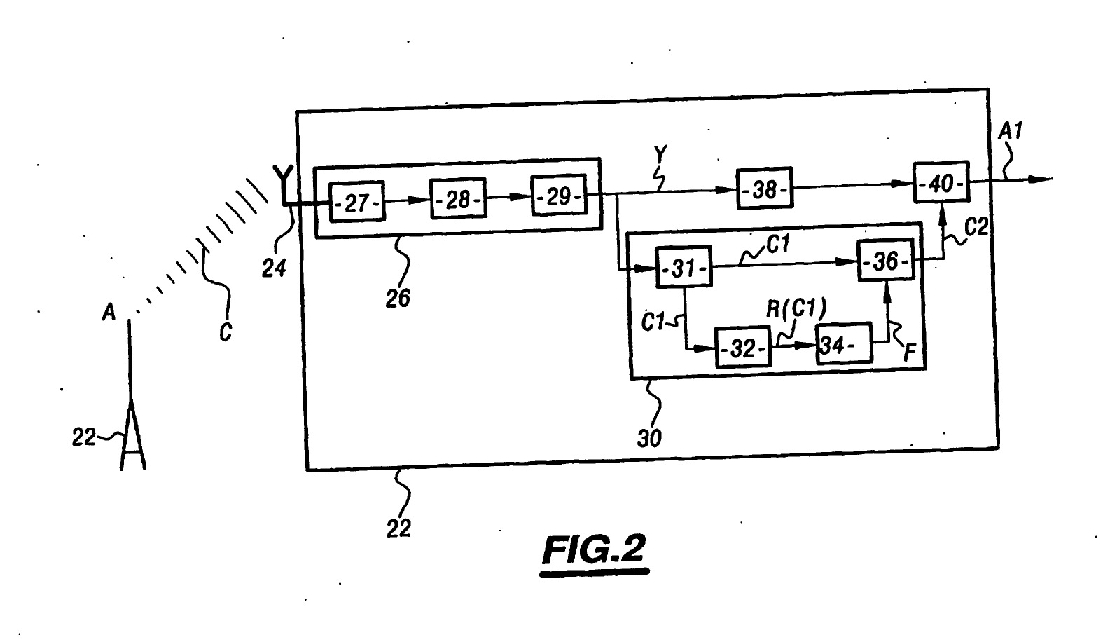

FIG. 2 is a functional diagram of apparatus for estimating the transfer function of a transmission channel in accordance with the invention.

FIG. 1 is a flow chart of the method of the invention.

The method begins with a step 2 of radio transmission of a multicarrier signal identified by the letter A.

For example, the signal A corresponds to a digital television signal modulated by orthogonal frequency-division modulation (OFDM).

The transmitted signal A includes a plurality of known items of reference information referred to as pilots.

For example, in OFDM signal transmission, one in twelve of the carriers is a reference carrier and is referred to as a pilot carrier.

Thereafter, the method comprise a step 4 of receiving a signal Y corresponding to the signal as transmitted and as modified by the transmission channel.

This reception step 4 comprises a plurality of processing substeps associated with the nature of the signal.

In the example of radio transmission of a digital signal with OFDM modulation, this reception step comprises, for example, a substep of converting the analog signal into a digital signal, a substep of transposition into base band, a substep of filtering and amplification, a substep of synchronization, and a substep of transformation from a time base to a frequency base.

This transformation substep corresponds to transforming the digital signal in the time domain into a representation thereof in the frequency domain, implemented for example using a fast Fourier transform (FFT).

These substeps are conventional substeps in methods of receiving a multicarrier signal and they can be organized in different orders and they can include other substeps depending on the nature of the transmitted signal.

At the end of the reception step 4, the signal Y as delivered is a digital signal in the frequency domain representing the energy distribution of the received signal as a function of frequency.

Writing the real transfer function of the transmission channel as C, it can be seen that the received signal Y is equal to the transmitted signal A modified by the transfer function of the transmission channel, with the addition of noise written B.

Thus: Y=C.A+B.

The noise B is the result of the noise that is inherent to disturbances in the transmission channel and also to the initial elements in the reception system, such as the tuner device or the amplifier, for example.

Thereafter, the method comprises a step 6 of calculating the value of an estimated first transfer function C1 of the transmission channel, which step is performed in conventional manner.

During this step 6, the presence of the pilot carriers in the received signal makes it possible to perform a substep of calculating the modifications to which these carriers have been subjected by comparing the received signal Y and the transmitted signal A in respect of the pilot carriers.

It can thus be seen that for the pilot carriers, the value of the transfer function C1p is available, where:

$$C1p = \frac{Y}{A} = C + \frac{B}{A}$$

By interpolating between the values for these ratios C1p relating to the pilot carriers, a first estimate of the transfer function C1 for the transmission signal is delivered.

Thereafter, the method comprises a step 8 of calculating the value of the autocorrelation function of the estimated first transfer function C1.

The assumption that the transmission channel is variable implies there will be variations in time in the transfer function of the transmission channel.

This autocorrelation function written R(C1) is calculated in conventional manner and serves to separate the contribution of noise from the transfer function of the signal.

This autocorrelation function R(C1) is used during a step 10 to determine a noise-removal filter, written F.

The noise-removal filter is obtained from the autocorrelation function using a technique that is known in the state of the art and an example known under the name Wiener filters is described on pages 446 to 453 of the book “Probability, random variables, and stochastic processes”, by Athanasios Papoulis.

Naturally, filters other than Wiener filters could be used for determining the noise-removal filter from the autocorrelation function R(C1).

During a step 12, the noise-removing filter F is applied, e.g. by a convolution product calculation, to the first estimated transfer function C1 of the transmission channel, thereby obtaining a second estimated transfer function of the transmission channel C2 from which noise has been removed.

Thus, C2=F*C1.

Thereafter, during a step 14, this second estimated transfer function C2 from which noise has been removed is used to correct the received signal in order to obtain an estimate A1 of the transmitted data, such that:

$$A1 = \frac{Y}{C2}$$

For a transmission channel that is varying, the method needs to be implemented periodically, and it is advantageously performed continuously on processing time windows of duration that corresponds to the duration of an OFDM symbol, for example.

When the method is implemented periodically, it is appropriate to define an operating period during which the variations in the transmission channel can be considered as being slow and continuous.

The method described can be implemented, for example, by a computer program or by a programmable component, having a logical configuration that is specially modified to enable calculation to be performed.

The program may also be stored in a non-volatile memory so as to be executed on a request coming from a microcontroller or a microprocessor, such as a microcontroller or a microprocessor integrated in a digital TV signal decoder, for example.

FIG. 2 shows a receiver unit including apparatus for estimating the transfer function in accordance with the invention.

In the figure, there can be seen a transmitter 20 such as a radio transmitter for a digital TV signal A that is OFDM-modulated and that is transmitted over the transmission channel as modelled by the transfer function C.

The signal is received by the receiver unit 22 using an antenna 24.

The received signal is then injected into a preprocessing system 26 which comprises, for example: an analog-to-digital converter 27, a synchronization module 28, and a module 29 for transforming from a time base to a frequency base using a fast Fourier transform (FFT), the module 29 implementing step 4 of the method as described above.

The preprocessing system 26 is connected at its output to a module 31 for calculating a first estimated transfer function by implementing step 6 of the method.

The module 31 has its output connected to a module 32 for calculating the value of the autocorrelation function, and its output is connected to a module 34 for determining a noise-removal filter.

These modules respectively implement steps 8 and 10 of the method of the invention.

The apparatus 30 for estimating the transfer function then comprises a module 36 for applying the noise-removal filter as determined by the module 34 to the estimated transfer function as calculated by the module 31, so as to implement step 12 of the method, and deliver a second estimated transfer function from which noise has been removed.

Thereafter, the receiver unit 22 comprises a delay module 38 for delaying the signal delivered by the preprocessing system 26 by the duration that is required for estimating the second channel transfer function from which noise has been removed. Finally, the unit 22 comprises a compensation module 40 implementing step 14 of the method and enabling the modification due to the transmission channel that occur in the delayed received signal to be compensated by using the second estimated transfer function C2 from which noise has been removed.

Thus, in operation, the signal A is transmitted from the transmitter 20 over the transmission channel C in order to be received by the antenna 24.

The received signal is digitized, synchronized, and transformed from a time base into a frequency base in the preprocessing system 26 so as to deliver the corresponding frequency-domain digital signal Y.

The signal Y is inserted into the apparatus 30 for estimating the transfer function.

The module 31 then determines what changes have occurred in the pilot carriers, and by interpolation delivers a first estimated transfer function C1 for the transmission channel. This estimated transfer function C1 is injected into the module 32 which calculates the autocorrelation function written R(C1).

Using the autocorrelation function, the module 34 for determining the filter uses Wiener's filter equations, for example, to determine the noise-removal filter F.

The module 36 then applies the filter F to the first estimated transfer function C1 in order to deliver the second estimated transfer function C2 from which noise has been removed.

In parallel with the calculation for estimating the transfer function, the frequency-domain digital signal Y is introduced into the delay module 38, after which the delayed signal Y is introduced into the module 40 which processes this signal as a function of the second estimated transfer function C2 from which noise has been removed in order to deliver the estimated data A1.

Thereafter, in the context of receiving a digital TV signal, the estimated data A1 is decoded and played back.

It can thus be seen that the apparatus for estimating the transfer function of a transmission channel in accordance with the invention enables the estimated transfer function of this transmission channel and from which noise has been removed to be calculated for a transmission channel that varies over time.

In particular, such apparatus is particularly suitable for use in a mobile receiver unit.

For example, such a receiver unit is integrated in a mobile handset for receiving terrestrial digital TV signals.

Furthermore, when implementing diversity reception in which a plurality of transmission channels and corresponding reception systems are used, each reception system can be fitted with apparatus of the invention, with all of the estimated data subsequently being processed by a decoder having inputs that are weighted using methods that are conventional in diversity reception.

1. A method of estimating the transfer function of a varying transmission channel for a multicarrier signal including a plurality of known reference data items referred to as pilots, said method being implemented from a frequency-domain digital signal corresponding to the signal as received, digitized, synchronized, and transformed from a time base to a frequency base, and including a step of calculating the value of a first estimated transfer function for the transmission channel on the basis of the pilots contained in said frequency-domain digital signal, wherein said step of calculating a first estimated transfer function comprises a substep of calculating the modifications to which the pilots have been subjected in order to define the value of the transfer function of the transmission channel for said carriers and a substep of interpolating between said values in order to deliver said first estimated transfer function, and wherein the method further comprises:
a step of calculating the value of the autocorrelation function of said first estimated transfer function enabling to separate out the contribution from noise;
a step of determining a noise-removal filter from said autocorrelation function; and
a step of applying said noise-removal filter to said first estimated transfer function in order to deliver a second estimated transfer function of the transmission channel from which noise has been removed.

2. A method according to claim 1, wherein the method is implemented periodically.

3. A method according to claim 1, wherein the method is implemented continuously.

4. A method of receiving a multicarrier signal, the multicarrier signal including a plurality of known reference data items referred to as pilots, said method being implemented from a frequency-domain digital signal corresponding to the signal as received, digitized synchronized, and transformed from a time base to a frequency base, the method comprising:
a step of calculating the value of a first estimated transfer function for the transmission channel on the basis of the pilots contained in said frequency-domain digital signal, wherein said step of calculating the value of a first estimated transfer function includes:
a substep of calculating the modifications to which the pilots have been subjected in order to define the value of the transfer function of the transmission channel for said carriers; and
a substep of interpolating between said values in order to deliver said first estimated transfer function;
a step of calculating the value of the autocorrelation function of said first estimated transfer function enabling to separate out the contribution from noise;
a step of determining a noise-removal filter from said autocorrelation function;
a step of applying said noise-removal filter to said first estimated transfer function in order to deliver a second estimated transfer function of the transmission channel from which noise has been removed; and
a step of compensating the modifications to which said multicarrier signal has been subjected during transmission on the basis of said second estimated transfer function from which noise has been removed, in order to deliver estimated data.

5. A method of receiving a multicarrier signal according to claim 4, wherein the method includes a plurality of prior steps of processing the received signal in order to deliver said frequency-domain digital signal.

6. A method according to claim 1, wherein said multicarrier signal is a digital TV signal modulated by orthogonal frequency-division multiplexing.

7. An apparatus for estimating the transfer function of a varying transmission channel for a multicarrier signal including a plurality of known reference items of information referred to as pilots, said apparatus receiving as input a frequency-domain digital signal corresponding to the signal as received, digitized, synchronized, and transformed from a time base to a frequency base, and including a module for calculating the value of a first estimated transfer function of the transmission channel from the pilots contained in said frequency-domain digital signal, wherein said module for calculating the value of a first estimated transfer function is adapted to determine the modifications to which the pilots have been subjected and to perform interpolation between said values in order to deliver said first estimated transfer function, the apparatus further comprising:
a module for calculating the value of the autocorrelation function of said first estimated transfer function enabling the contribution of noise to be separated out;
a module for determining a noise-removal filter from said autocorrelation function; and
a module for applying said noise-removal filter to said first estimated transfer function in order to deliver a second estimated transfer function of the transmission channel from which noise has been removed.

8. An apparatus according to claim 7, wherein the apparatus is configured to operate periodically.

9. An apparatus according to claim 7, wherein the apparatus is configured to operate continuously.

10. A receiver unit for receiving a multicarrier signal, the multicarrier signal including a plurality of known reference items of information referred to as pilots, said receiver unit receiving as input a frequency-domain digital signal corresponding to the signal as received digitized, synchronized, and transformed from a time base to a frequency base, and including a module for calculating the value of a first estimated transfer function of the transmission channel from the pilots contained in said frequency-domain digital signal, wherein said module for calculating the value of a first estimated transfer function is adapted to determine the modifications to which the pilots have been subjected and to perform interpolation between said values in order to deliver said first estimated transfer function the receiver unit further comprising:
a module for calculating the value of the autocorrelation function of said first estimated transfer function enabling the contribution of noise to be separated out;
a module for determining a noise-removal filter from said autocorrelation function;
a module for applying said noise-removal filter to said first estimated transfer function in order to deliver a second estimated transfer function of the transmission channel from which noise has been removed; and
a module for compensating the influence of the transmission channel in order to modify said frequency-domain digital signal as a function of said second estimated transfer function from which noise has been removed, in order to deliver estimated data.

11. A receiver unit according to claim 10, wherein the receiver unit further includes a preprocessing system adapted to receive said multicarrier signal, and to deliver said frequency-domain digital signal.

12. A receiver unit according to claim 10, wherein the receiver unit is configured to receive digital TV signals modulated by orthogonal frequency-division multiplexing.

13. A receiver unit according to claim 10, wherein the receiver unit is configured to be mobile.

14. A computer program product residing on a computer readable medium having a plurality of instructions stored thereon which, when executed by the processor, cause that processor to:
calculate, from a frequency-domain digital signal corresponding to a multicarrier signal as received, digitized, synchronized, and transformed from a time base to a frequency base, the value of a first estimated transfer function for a varying transmission channel for said multicarrier signal on the basis of pilots contained in said frequency-domain digital signal, wherein calculating the value of the first estimated transfer function includes:
calculating the modifications to which the pilots have been subjected in order to define the value of the transfer function of the transmission channel for said carriers; and
interpolating between said values in order to deliver said first estimated transfer function;
calculate the value of the autocorrelation function of said first estimated transfer function enabling to separate out the contribution from noise;
determine a noise-removal filter from said autocorrelation function; and
apply said noise-removal filter to said first estimated transfer function in order to deliver a second estimated transfer function of the transmission channel from which noise has been removed.

15. A program component, including a logic configuration, configured to:
calculate, from a frequency-domain digital signal corresponding to a multicarrier signal as received, digitized, synchronized and transformed from a time base to a frequency base, the value of a first estimated transfer function for a varying transmission channel for said multicarrier signal on the basis of pilots contained in said frequency-domain digital signal, wherein calculating the value of the first estimated transfer function includes:
calculating the modifications to which the pilots have been subjected in order to define the value of the transfer function of the transmission channel for said carriers; and
interpolating between said values in order to deliver said first estimated transfer function;
calculate the value of the autocorrelation function of said first estimated transfer function enabling to separate out the contribution from noise;
determine a noise-removal filter from said autocorrelation function; and
apply said noise-removal filter to said first estimated transfer function in order to deliver a second estimated transfer function of the transmission channel from which noise has been removed.
